(19) United States
(12) Patent Application Publication
(10) Pub. No.: US 2009/0194481 A1
(43) Pub. Date: Aug. 6, 2009

(54) Agglomerated MIP Clusters

(76) Inventors: Ecevit Yilmaz, Bjarred (SE); Anthony Rees, Furulund (SE); Johan Billing, Lund (SE)

Correspondence Address: SCHWEGMAN, LUNDBERG & WOESSNER, P.A., P.O. BOX 2938, MINNEAPOLIS, MN, 55402, US

(21) Appl. No.: 12/085,259

(22) PCT Filed: Dec. 6, 2006
(86) PCT No.: PCT/SE2006/050547

§ 371 Date: Feb. 2, 2009

(30) Foreign Application Priority Data
Dec. 7, 2005 (SE) 0502699-2
May 12, 2006 (SE) 0601067-2

(51) Int. Cl. B01J 20/285; B01J 2/06; B01J 20/30; C08L 33/02

(52) U.S. Cl. 210/656; 210/502.1; 525/221

(57) ABSTRACT

The present invention relates to a composite material obtainable by agglomerating molecularly imprinted polymer particles, and the use of said composite material in separations such as chromatographic separation, a filtration process, continuous or discontinuous membrane process, analytical separation, or a preparative or large-scale separation.

### TECHNICAL BACKGROUND

Molecularly imprinted polymers (MIPs) were first described more than 30 years ago (Wulff, G., and A. Sarhan. 1972, Angew. Chem. 84 (8):364). This polymer-based nanotechnology enables the preparation of polymeric phases that are highly selective towards desired target compounds. For the synthesis of a given phase, a template, relevant functional and cross-linking monomers, a porogenic solvent and a polymerization initiator are the basic building blocks. The majority of such MIPs are produced by the so-called block-polymer process (also sometimes called bulk-polymerisation), which is essentially a concentrated solution polymerisation process. MIPs have found applications in the areas of separations, diagnostics, sensors and drug delivery. For separations, such as in chromatography, there are narrow ranges of particle sizes of such polymer phases that are ideal for effective separation processes. For example, during analytical HPLC particle sizes in the range of 5-20 μm are widely used. Smaller particles possess larger surface area to mass ratios than larger particles but typically exhibit unacceptably high back-pressures. By contrast, large particles (e.g. ≧100 μm) present low back-pressures but because they possess a smaller surface area to mass ratio, their use results in poorer separations. Large particle sizes are especially desirable in large-scale processes in industry where the employment of powerful liquid pumps is either not feasible, or practically difficult to implement, or presents a high cost factor for both initial plant investment and subsequent running costs.

The majority of the MIP prior art has focused on the production of block polymer MIPs for use in solid phase extraction as a separation method where the requirement typically is for particles in the 20-90 μm size range. The production of such particles using these processes usually employs grinding and sieving steps with material yields in the desired range of around 50%, the remainder typically being MIP particles much less than 20 μm. There are also examples of newer processes that lead to particles in the sub-micron to micrometer range. For example, in 1994, Sellergren described a method for producing discrete MIP particles of this size range in a dispersion system (Sellergren, B. 1994. J. Chromatogr. A 673:133-141), prepared in-situ inside a column. This process was termed “dispersion polymerization” and yields small irregular MIP particles that appear as agglomerates of even smaller particle units. The size of the particles produced by this process (0.5-4 micrometers) is not amenable to large scale production and in any case is not useful for large-scale chromatographic applications.

The group of Mosbach (Mosbach et al US 2004/0063159 A1) used a similar system to that of Sellergren for producing precipitated particles but with monomer concentrations lower than either block polymer MIPs or MIPs produced in the dispersion system, leading to even smaller discrete particles. Again, others have synthesized MIP particles in the sub-micrometer range by mini-emulsion polymerisation methods (Vaihinger et al, Macromol. Chem. Phys., 2002, 1965-1973).

As indicated above, small (e.g. micron or sub-micron) MIP particles can be produced by a variety of polymerisation methods including dispersion, precipitation and emulsion polymerisation. However, block polymerisation is the most common method for molecular imprinting and many examples are presented in imprinting textbooks (Sellergren, B, Molecularly Imprinted Polymers: Man made mimics of antibodies and their application in analytical chemistry. B. Sellergren Ed.) Elsevier publishers, 2001 (22 chapters, 550 pages). Small particles with sub-micron diameters are usually an undesired side product produced by this method which, as indicated above, normally targets usable particles in the 20-90 μm range. Typically, these small MIP particles constitute up to 50% of the total polymer mass after the grinding process. If excessive grinding is carried out, yields close to 100% of small MIP particles can be obtained.

MIP particles produced by dispersion or precipitation polymerisation methods can also give high yields of small particles and furthermore, the small MIP particles are obtained without the need for grinding and sieving processes. In the case of the precipitation process, relatively high amounts of template are required in order to yield sufficiently well imprinted small MIP particles. It has been shown that these small MIP particles exhibit improved recognition abilities compared to MIP particles produced from block polymers. In one example, an enzyme-bound analyte was able to specifically rebind to the precipitated small MIP particles, whereas the same enzyme-bound analyte was unable to bind to the standard MIP particles produced by block polymerisation. The comparison of these two types of materials is presented in the work of Surugiu et al. (Surugiu et al 1999, Analyst, 2000, 125, 13-16). This type of precipitated (small) MIP particle which has so far only been used in sensor and assay applications, has not been utilized in chromatographic processes because of the associated high back pressures.

Similarly, small MIP particles can be obtained by emulsion polymerization techniques but suffer from the same use limitations as the precipitation polymerisation material.

As disclosed above many polymerization methods leading to formation of molecularly imprinted particles are known in the art. However, the molecularly imprinted particles are often too small to be useful in separations, in particular in chromatographic separations. Such small particles are typically in the sub-micrometer or low micrometer size range. Emulsion and precipitation polymerization are examples of polymerization methods which generate molecularly imprinted particles that are typically not possible to use in flow-through separation methods such as chromatography due to high back pressures and a lack of devices that can handle such small particles. Consequently there is a need for a molecularly imprinted separation material having properties such as an optimal bead size, e.g. between 5 and 1000 micrometers and whose bead preparations are preferably spherical.

### SUMMARY OF THE INVENTION

The object of the present invention is to prepare materials that have improved properties, e.g. for use in separations, filters or other processes, compared to commonly used materials, and wherein the material according to the present invention combines the advantages of small MIP particles which posses a large surface area to mass ratio with the advantages of low back pressures and ease of handling possessed by large particles. The object of the present invention is achieved by a composite material obtainable by agglomerating small MIP particles into large beads.

One object of the present invention is to make preformed molecularly imprinted particles, that possess the necessary properties, such as an appropriate size, e.g. small molecularly imprinted particles, and which are possible to use in separations, e.g. chromatography.

The object of the present invention is achieved by a composite material obtainable by agglomerating molecularly imprinted particles, wherein said molecularly imprinted particles are preformed prior to being agglomerated.

The object of the present invention is also achieved by forming an agglomerate of MIP particles, wherein said agglomerate of MIP particles is formed by:
a) encapsulation of MIP particles by forming a shell around at least two MIP particles, or
b) interlinking of MIP particles by forming a chemical bond between at least two MIP particles using an inter-linkage agent, or
c) entrapment of MIP particles by copolymerizing MIP particles in the presence of monomers and optionally solvents.

### SHORT DESCRIPTION OF THE FIGURES

FIG. 1 illustrates a bead that contains an agglomerate of small MIP particles. The illustration indicates that the bead may be cross-linked with interlinking polymer strings.

FIG. 2 schematically illustrates the synthesis of small MIP particle agglomerates via a suspension process. Due to thermodynamic partitioning of the hydrophobic small MIP particles and the hydrophobic monomer mixture, the system forms two phases in water, i.e. a two-phase system. Upon stirring, droplets are formed—these droplets polymerize and yield then agglomerates of small MIP particles inside a polymer bead. In the inverse case, hydrophilic small MIP particles and a hydrophilic monomer mixture are suspended in a hydrophobic medium, such as heptane.

FIG. 3 illustrates the formation of small MIP particle clusters by inter-linkage of the particles with each other. The inter-linkage can. either lead to discrete beads that contain a limited number of small MIP particles or they can be in other forms, such as filters or membranes.

FIG. 4 depicts a schematic presentation of small MIP particles encapsulated forming a bead consisting of small MIP particles. The formed shell around the small MIP particles keeps the agglomerate together.

FIG. 5 illustrates a monolith column that is produced by the present invention. The monolith polymer contains both small MIP particles and pores that allow for liquid flow.

FIG. 6 illustrates an comparison of particle size distribution of small MIP particles and larger beads consisting of agglomerated small MIPs. First curve (left peak). Particle size distribution of small MIP particles. Second curve (right peak). Particle size distribution of small MIP particle beads after agglomeration.

### DETAILED DESCRIPTION OF THE PRESENT INVENTION

The present invention relates to a composite material that is obtained by a method with which MIP particles, such as small MIP particles, can be processed further to produce larger beads or other formats. In one embodiment of the present invention, preformed molecularly imprinted particles that do not possess the necessary properties, such as an appropriate size, e.g. small molecularly imprinted particles, are agglomerated to form a composite material having the desired properties, e.g. an appropriate size and other characteristics. The resulting composite material is then useful in separations, such as chromatographic separations as well as other separations known to a person skilled in the art, such as filtrations, batch separations and membrane separations. The formed MIP particles, preferably in the form of beads may result in improved separations, as disclosed herein.

Work carried out by the inventors has shown that a chromatographic column packed with intermediate sized (i.e. 20-90 μm) MIP particles can separate a mixture of saccharide compounds only to a limited extent and yield low ‘resolution factors’. The same material but ground to smaller overall particle diameters (i.e. 5-20 μm) in the same chromatographic column improves the separation and resolves the same compound mixture with base-line separation. The total surface area and hence availability of MIP binding sites of the small MIP particles leads to a higher number of theoretical plates giving better resolution of the given mixture. At the same time the small particle size MIP exhibits a higher capacity. A factor that is likely to play a role in the improved separation is the improved diffusion behaviour in such small MIP particles. Unfortunately, the column packed with small MIP particles, as expected, possesses a high back-pressure which adversely affects the flow velocity. Were even smaller particles to be used to improve the resolution further, the back pressures would become unacceptably high and would render the separation process impossible.

A new material that could combine the high surface area and capacity of small particles, with the low back-pressure of larger particles, would contribute a significant advance to the separations field. The stated objective of such a new material would be consistent with known theory. In one term of the Van Deemter equation the theoretical plate height (Hp) is related to the flow velocity:

Hp=2λdₚ

Where Hp is the theoretical plate height variation with flow velocity, dp is the particle diameter and λ is a constant related to particle size distribution. Clearly, as dp gets smaller Hp gets smaller leading to high separation efficiency. However, a small dp also results in a large back-pressure, creating practical problems in separation for large scale applications where such high pressures cannot be practically managed.

According to the present invention small MIP particles are MIP particles having a diameter of less than 10 μm, preferably less than 5 μm, most preferred less than 1 μm. Typical methods to prepare such small MIP particles in the range of 0.01 to 10 μm in diameter are dispersion polymerization, precipitation, emulsion and bulk polymerization, followed by subsequent grinding. When their size is in the nm scale, they are sometimes referred to as “nanoparticles”. A person skilled in the art realizes that other polymerisation and polymer methods exist for producing small MIP particles that may be used to prepare the agglomerated particles according to the present invention.

Molecularly imprinted polymers (MIPs) are produced by polymerizing monomers and cross-linkers in presence of a template in a solvent After polymerization, the template is washed out to leave behind binding sites into which the template and similar molecules can rebind with a certain specificity. Mosbach discloses in U.S. Pat. No. 5,110,833 how MIPs are produced for use in enzymatic or affinity applications. MIPs can be made towards many different targets and they display many different selectivities, such as those summarized in the textbook edited by Sellergren ((Sellergren, B. Molecularly Imprinted Polymers: Man made mimics of antibodies and their application in analytical chemistry. B. Sellergren (Ed.) Elsevier publishers, 2001. A molecularly imprinted polymer may typically be prepared as follows: 1 mmol of template, for example propranolol or theophylline, 4 mmol of methacrylic acid, 20 mmol of ethyleneglycol methacrylate or divinylbenzene and 0.5 mmol azoisobutyronitrile are dissolved in an organic solvent, such as chloroform, toluene or acetonitrile. After complete dissolution of all components, the solution is purged with nitrogen for 2 minutes and then heated to 65° C. or irradiated under a UV light for 16 h, to polymerize. After polymerization, the obtained polymer block is ground and sieved and then extensively washed with for example methanol and acetic acid. Depending on grinding and sieving, various particle size ranges may be obtained.

Typically, such particles are ground and sieved to obtain particles of size 20-90 μm. If the grinding is done excessively, the whole MIP batch can be converted to small MIP particles of sizes smaller than 10 μm.

Pores are classified according to their diameter where micropores have diameters less than about 2 nm, mesopore sizes range from about 2 nm to about 50 nm and macropores have diameters greater than 50 nm. “Flow-through pores” may be even larger such as in the μm range.

According to the present invention “agglomerate” or “cluster” means particles that are held together as a group. In the present invention, beads, agglomerates and clusters may be used interchangeably although agglomerates and clusters may also be used to describe other multi-particle formats. For example, an agglomerate of particles may be a few particles, e.g. 10, held together in a group that may have the shape of a bead, or any other shape. An agglomerate may also be a group of a much larger number of particles, e.g. 10¹⁵, that are present as a group in a single bead, or any other shape, such as a filter having the shape of a disk. Of course many other shapes, such as fibres, tubes etc as agglomerates may be envisaged by a person skilled in the art.

As used in the present invention “composite” is intended to mean, a material wherein a molecularly imprinted polymer and a second material are comprised. For example, a material consisting of a molecularly imprinted polymer and a second type of material may be considered a composite material. One example of a composite material of MIP is described in Yilmaz et al (J. Materials Chemistry, 2002, 12, 1577-1581), where porous silica is filled with a MIP. Said document does not disclose MIP agglomerates.

A shell can be any material that keeps at least two MIP particles together. The obtained MIP composite shell can have many formats or shapes, but spherical particles are a preferred format.

The terms “MIP particles” and “molecularly imprinted particles” are used interchangeably herein.

Particles that are smaller than 5 micrometer in diameter are generally considered not useful for the majority of chromatographic applications. There are some new developments for analytical applications, that may use particles in the low micrometer range but requires expensive equipment and very high pressures to operate.

Especially for large-scale separations in industry larger particle sizes are preferred. It is preferred that the particles are at least 10 micrometer up to several mm in size. There is a direct relationship between particle size and backpressure, namely, the larger the particle, the lower the backpressure.

One embodiment of the present invention relates to a method for preparation of agglomerated MIP particles having a size of at least 5 μm, preferably 5-5000 μm, formed by creating agglomerates of small MIP particles, constituting a composite material in the form of bead or any other shape. For some applications, the composite materials preferably are in the form of a bead in the size range 5-5000 μm, preferably in the size range 10-1000 μm, or in the size range 100-500 μm. In analytical separations under high pressure, the preferred size range of the composite material is between 5-20 μm, for low pressure analytical separations, the preferred size range is 20-100 μm. Other preferred shapes are disks, possible to use as filters, with size diameters of 1-100 mm. Additionally composite materials, such as filters with much larger dimensions, may be used for large-scale applications and separations.

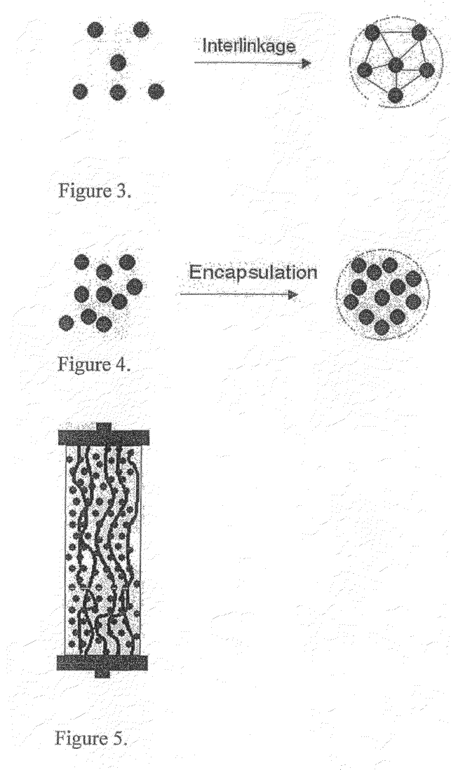

Small MIP particles can also be linked together to form agglomerates held together by inter-linkage. FIG. 3 illustrates this concept where the small MIP particles are linked together by chemical compounds that link the particles together and the thus formed agglomerate forms a bead having a size larger than the individual particle. Compounds that may be used to create such an inter-linkage are linear or branched molecules that carry terminal functionalities that may be used to couple to the small MIP particles. For example, long-chain alkanes, polyethylene glycol, glutardialdehyde or other oligomers, macromolecules or polymers with appropriate terminal functional groups are useful for inter-linkage. Reactive terminal functionalities comprise activated carboxyl-groups such a acid chlorides or anhydrides but also isocyanates, azides, epoxides and other activated chemical entities, which are known to the person skilled in the art. Inter-linkage can also be accomplished, e.g. by activating carboxyl-groups in the MIP particle. Activation of carboxyl-groups may e.g. be done with carbodiimides—this chemistry is widely used in e.g. solid phase reactions. Such activated MIP particles are then able to react and couple with e.g. diaminohexane, diamino-PEG or other terminally functionalized compounds.

Separation materials are materials that have the ability to separate molecules in a separation process. Molecules are separated depending on their interaction with the separation material during the separation process. Separation materials are for example based on inorganic materials such as silica, organic polymers, such as divinylbenzene and styrene, or biopolymers, such as agarose. For example, a hydrophobic separation material retains hydrophobic compounds more than it retains hydrophilic compounds. In chromatography for example, hydrophilic compounds would be eluted first and hydrophobic compounds would be eluted last from such a separation material. Separation materials usually have the shape of beads, filters, membranes, tubes, but may have also other shapes. Separation materials may be packed into columns, cartridges, and other containers. But they can also be used as filters or as membranes or as tubes.

In chromatography and other separation processes, the size of the packing material has implications on the separation performance. Advantages of small particles compared to large particles are that they have a large surface area and thus a large interaction area for molecules. Also, diffusion pathways of molecules are short in small particles. On the other side, small particles cause high back pressures in columns. This limits them from being used in many separation processes, especially large-scale separation processes used in the industry.

One advantage of large particles is that their handling is easier than small particles, for example, they settle faster in a suspension. Also, in chromatographic applications, large particles exhibit relatively low back-pressure to the flow of solvents. Usually, the larger the particles are, the lower the back-pressures.

By forming agglomerates, such as described in the present invention, the advantages of the small particles may be combined with the advantages of large particles.

According to the present invention the composite material, comprised of agglomerates of small particles, such as small MIP particles, may have the following advantages over common particles of the same size.
1. higher surface areas resulting in an enhanced accessibility to active or selective sites.
2. smaller resistance to liquid flow in chromatographic separations.
3. larger macro-pores may be incorporated in beads or other shapes for enhanced flow properties, allowing macromolecules, cells and other larger compounds to enter the separation material.
4. small MIP particles with low mechanical stability may be more stable as an agglomerate and therefore useful in high pressure applications
5. higher capacity separation material, compared to common particles of the same size.
6. by agglomeration, small MIP particles previously not useful in chromatography, may according to the present invention be used in separations, e.g. as packing material in chromatographic columns, or in other separations.

In one embodiment of the invention small MIP particles are first produced, and thereafter agglomerated. Preferably, these agglomerates are in the shape of beads.

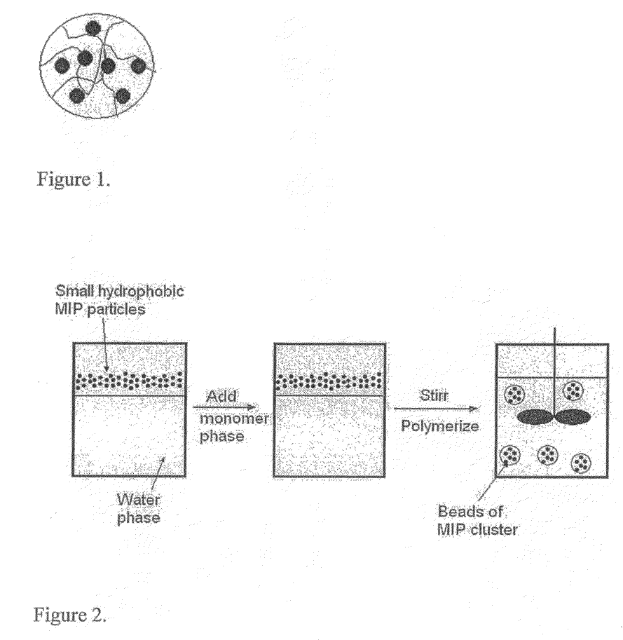

In one embodiment, as described in FIG. 1, small MIP particles may be incorporated in larger particles, e.g. beads, by various entrapment methods. The entrapment of small MIP particles may take place during a polymerization process. During said polymerization process small MIP particles may be incorporated inside beads. For example, if small MIP particles are suspended in water, they are repelled by the polar water phase and do not get wetted. They rather form agglomerates or lumps on the surface and do not distribute evenly in the water phase. If then an apolar monomer phase (e.g. divinylbenzene and styrene) is added to the said water phase containing the small MIP particles, the small MIP particles will enrich in the monomer phase due to thermodynamic partitioning. The driving force is that the chemical similarity—both small MIP particles and monomers are hydrophobic, which allows the small MIP particles to be within the hydrophobic monomer phase but separated from the water phase. The systems consist of two immiscible phases and is hence termed a two-phase system. Stirring of the water-monomer-small MIP particles mixture will result in droplets of monomer. The hydrophobic small MIP particles will be inside these monomer droplets. Thus, the small MIP particles are incorporated or entrapped inside the polymer droplets and this material is then a composite material comprising an agglomerate of small MIP particles inside a divinyl benzene-styrene copolymer matrix. This process is schematically illustrated in FIG. 2. The relative sizes of small MIP particles and final beads are simplified in FIG. 2 for a more convenient description.

Residual polymerizable chemical groups (e.g. vinyl, methacrylic) normally present in highly cross-linked MIP particles after their production, allow incorporation of additional polymerization monomers by a further co-polymerisation step. For example, small MIP particles may be co-polymerized with a monomer, such as methylmethacrylate or styrene, in a solvent, such as toluene, acetonitrile or methanol and optionally in a dispersion medium such as water or heptane. The residual polymerizable groups on the small MIP particles will mediate the linkage of the particles to each other via the polymerizing monomers leading to the formation of beads or other structures. Due to the presence of multiple polymerization groups on the particle surface or within their pores one particle will be able to be get interlinked to several other particles. In FIG. 3, this process is schematically illustrated.

In one embodiment according to the present invention small MIP particles are entrapped during a coagulation process. This coagulation process leads mainly to a coating of an agglomerate of small MIP particles. Small MIP particles may be for example coagulated in alginate. The small MIP particles are mixed with sodium alginate and then contacted with a Ca²⁺ solution. This can be performed by dropping a mixture that contains small MIP particles and sodium alginate into the Ca²⁺ solution. Ca²⁺ is usually CaCl₂ dissolved in an aqueous solvent. Further details of how to perform the entrapment of small MIP particles in alginate beads is known to the person skilled in the art. The entrapment according to this embodiment is performed with appropriate polymers or biopolymers, such as polystyrene, polyacrylic acid cellulose, agarose, alginate polyvinylalcohol (PVOH) or polyvinylpyrrolidone. The entrapment forms a shell around the small MIP particles, resulting in a composite material according to the invention.

In a further embodiment of present the invention, agglomerates of small MIP particles are formed by spray drying. Small MIP particles are suspended in a solvent such as water that contains, for example, polyvinylalcohol and an cross-linking additive, such as an aldehyde, of which glyoxal, a simple dialdehyde, is the most common, along with higher aldehydes, such as gluteraldehyde and hydroxyadipaldehyde; thermosetting resins, such as urea-formaldehyde and melamineformaldehyde; and salts of multivalent anions, such as zirconium ammonium carbonates. The spray-drying instrument sprays the suspension through an orifice to form small droplets of suspended MIP particles in solvent. By varying the spray adjustments, such as the spray pressure, the flow the speed and also the drying air flow, the size of the droplets and thus the size of the agglomerates are controlled. Both concurrent and counter current air flows that dry the droplets may be used. The thus formed agglomerates will be cross-inked with for example glyoxal and PVOH. The cross-linkage of PVOH will hold the agglomerate of small MIP particles firmly together. The agglomerates may also be formed, as described above, by entrapment in, for example, alginate or another polymer.

The interstitial volume of agglomerated MIP particles in a bead is the dominating factor for the porosity of the bead. This porosity may be engineered in terms of pore size and volume, by control of monomer and cross-linker concentration, ratio (degree) of cross-linkage and concentration of small MIP particles. For example a low degree of cross-linker used to form the small MIP agglomerates would lead to large flow-through pores and would be accessible for larger analytes, such as proteins or-cells. A high degree of cross-linker will lead to smaller pores. A high concentration of monomers and cross-linkers will lead to a low surface area and a low concentration of monomers and cross-linkers will lead to larger surface areas. Addition of further solvents, such as octanol causes the formation of macropores in the final bead. Octanol forms a third phase within the organic phase and forms additional pores in the final bead that facilitates the overall flow characteristics of the cluster. A high content of small MIP particles will lead to a lower pore volume in the agglomerated bead.

It is desirable to maximise the number of entrapped MIP particles, to obtain an even distribution of small particles throughout the bead, to obtain a mechanically stable bead and to provide an unhindered flow through the particles. However, the amount of entrapped MIP particles in a bead or a material may vary depending on the applications. It may be as little as 0.1 weight % of MIP particles entrapped in the material, or it could be as high as 99 weight %. Preferably, the amount of entrapped MIP particles in a bead or material is between 10-90 weight %.

For industrial scale applications, most of the above mentioned approaches using precipitation, emulsion, dispersion or bulk polymerization that were described in the prior art that can provide small MIP particles are not feasible. In general they have too small particle sizes or have far too low yields per batch.

MIP particles in the lower micrometer regime can be produced following the processes outlined in the present invention in large quantities under industrially feasible conditions. The present invention presents a way to produce composite materials of MIP agglomerates at industrial scale under economically feasible conditions.

### EXAMPLES

### Example 1. This Example is Schematically Illustrated in FIG. 2

### Formation of Agglomerated Small MIP Particles into Larger Beads by Suspension Polymerisation

1 g of small MIP particles are mixed with a monomer mixture consisting of 1 g of methylmethacrylate (MMA), 0.2 g of ethyleneglycol dimethacrylate (EDMA), 1 ml toluene and 100 mg azoisobutyronitril (AIBN). This mixture of monomer and small MIP particles is thoroughly mixed, sonicated, degassed and purged with nitrogen. It is then added to 50 ml of water that contains 1% polyvinylalcohol (PVOH) followed by stirring of the two-phase system to yield clustered particles in the 50 μm size range. Polymerization is then induced by heat. After over-night polymerisation, the particles are harvested by filtration or centrifugation and washed with appropriate solvents.

### Example 2

### Incorporation of Flow-through Pores of Particles from Example 1

1 g of small MIP particles are mixed with a monomer mixture consisting of 1 g of methylmethacrylate (MMA), 0.2 g of ethyleneglycol dimethacrylate (EDMA), 1 ml toluene, 0.5 ml octanol and 100 mg azoisobutyronitril (AIBN). This mixture of monomer and small MIP particles is thoroughly mixed, sonicated, degassed and purged with nitrogen. It is then added to 50 ml of water that contains 1% polyvinylalcohol (PVOH) followed by stirring of the two-phase system to yield clustered particles in the 50 μm size range. Polymerization is then induced by heat. After over-night polymerisation, the particles are harvested by filtration or centrifugation and washed with appropriate solvents.

### Example 3. This Example is Illustrated in FIG. 3

### Formation of Small MIP Particles Agglomerates by Inter-linkage

1 g of small MIP particles are added to 100 ml of acetonitril containing an activated polymeric agent (ca. 1% w/w), such as PEG that has terminal azide groups. This mixture is stirred to yield clustered particles in the 5-500 μm size range. UV irradiation causes the azide groups to react with appropriate groups in the MIP particle and thus inter-link the individual particles to an agglomerate.

### Example 4. This Example is Illustrated in FIG. 4

### Encapsulation of Small MIP Particles Agglomerates

1 g of small MIP particles are mixed with sodium alginate in water. This suspension is dropped into a stirred aqueous solution containing CaCl2 leading to bead agglomerates of small MIP particles that are encapsulated in alginate.

### Example 5. This example is illustrated in FIG. 5

### Preparation of In-situ Materials and Incorporation of Flow-through Pores in Column

1 g of small MIP particles are mixed with a monomer mixture consisting of 1 g of MMA, 0.2 g of EDMA, 1 ml toluene, 0.5 ml octanol and 100 mg AIBN. This mixture of monomer and small MIP particles mix is thoroughly mixed, sonicated, degassed and purged with nitrogen. It is then poured into a sealed container, such as an HPLC column, and allowed to polymerise. Polymerisation results in a monolithic material that consists of an agglomerate of MIP particles in a MMA-EDMA copolymer.

### Example 6

### Preparation of Agglomerated Small Particles Beads by Spray Aggregation

1 g of small MIP particles is suspended in 10 ml of water containing PVOH and glyoxal, and then pressed through a small orifice such as a nozzle. In this process each droplet contains small MIP particles. During the spray drying process, the water is removed which yields a bead that consist of agglomerated MIP particles. Depending on the process parameters, physically agglomerated MIP clusters can be obtained in the size range of 1 μm to a few hundred μm. Cross-linkage of the incorporated small MIP particles occurs by reaction of PVOH with glyoxal. This cross-reaction solidifies the particles and ensures the integrity of the small MIP particles as a bead.

### Example 7

### Encapsulation of Small MIP Particles into Polystyrene-divinylbenzene

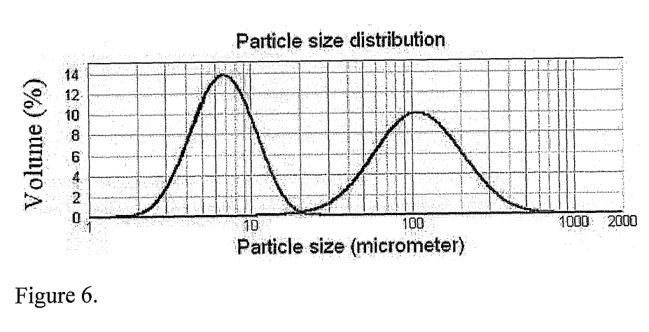

0.74 g of small MN particles particle size distribution around 7 μm as shown in FIG. 6) are suspended in a continuous phase consisting of 12 ml water containing 0.5 w % polyvinyl alcohol (molecular weight=2000, 75% hydrolyzed) and stirred for 1 h and then purged with nitrogen for 5 minutes. A monomer mixture consisting of toluene (1,1 ml), styrene (0.74 g) and divinylbenzene (0.092 g) and azoisobutyronitril (14 mg) was prepared and the purged with nitrogen for 2 minutes. The monomer mixture was added to the suspended small MIP particles and mixed by stirring and then the suspension was heated to 60° C. under reflux. After over night polymerization a fraction of large and heavy particles, which are the agglomerated composite materials, was obtained. As shown FIG. 6, the resulting particle size of this fraction is now 100 μm.

1. A composite material obtainable by agglomerating molecularly imprinted polymer particles, wherein said MIP particles are pre-formed prior to being agglomerated.

2. A composite material according to claim 1, wherein said composite material is obtainable by forming an agglomerate of MIP particles, wherein said agglomerate of MIP particles is formed by:
a) encapsulation of MIP particles by forming a shell around at least two MIP particles, or
b) interlinking of MIP particles by forming a chemical bond between at least two MIP particles using an inter-linkage agent, or
c) entrapment of MIP particles by copolymerizing MIP particles in the presence of monomers and optionally solvents.

3. A composite material according to claim 2, wherein said inter-linkage agent is selected from linear or branched molecules having terminal functionalities with the abilities to couple to said MIP particles.

4. A composite material according to claim 2, wherein said shell is formed by using polystyrene, agarose or alginate as an encapsulation agent.

5. A composite material according to claim 3, wherein said terminal functionalities are selected from the group consisting of acid chlorides, anhydrides, isocyanate, azides or epoxides.

6. A composite material according to claim 2 wherein said composite material is obtained in-situ.

7. A composite material according to claim 2, wherein said composite material is obtained in a suspension process.

8. A composite material according to claim 1, wherein said MIP particles have a diameter of less than 10 μm.

9. A composite material according to claim 2, wherein residual polymerizable functionalities in said agglomerate of MIP particles are copolymerized with at least one monomer.

10. A composite material according claim 9, wherein said monomers are selected from the group consisting of vinylic, acrylic and methacrylic monomers and cross-linking monomers.

11. A composite material according to claim 1, wherein said agglomerates of MIP particles are beads.

12. A composite material according to claim 1, wherein said agglomerates of MIP particles include at least one of filters, membranes, layers, hollow tubes or fibers.

13. A composite material according to claim 1, wherein said agglomerates of MIP particles are in the size range from 5 to 5000 μm.

14. A composite material according to claim 13, wherein said agglomerates of MIP particles are in the size range from 10 to 1000 μm.

15. Use of a composite material according to claim 1, in a chromatographic separation, a filtration process, continuous or discontinuous membrane process, analytical separation, or a preparative or large-scale separation.

16. Use of a composite material according to claim 1, wherein the composite material is used as a packing material in chromatographic columns.

17. A composite material according to claim 2, wherein said MIP particles have a diameter of less than 10 μm.

18. A composite material according claim 2, wherein said monomers are selected from the group consisting of vinylic, acrylic and methacrylic monomers and cross-linking monomers.

19. A composite material according to claim 1, wherein said MIP particles are obtained by: a) providing monomers, template, crosslinker and an initiator in a solvent; b) polymerizing the mixture obtained in a); and c) removing the template obtaining said MIP particles.

20. A composite material according to claim 2, wherein said MIP particles are obtained by: a) providing monomers, template, crosslinker and an initiator in a solvent; b) polymerizing the mixture obtained in a); and c) removing the template obtaining said MIP particles.
